(19) United States
(12) Patent Application Publication
(10) Pub. No.: US 2018/0247055 A1
(43) Pub. Date: Aug. 30, 2018

(54) METHODS FOR PROTECTING A HOST DEVICE FROM UNTRUSTED APPLICATIONS BY SANDBOXING

(71) Applicant: QUALCOMM Incorporated, San Diego, CA (US)

(72) Inventors: Walker Curtis, San Diego, CA (US); Giridhar Mandyam, San Diego, CA (US)

(21) Appl. No.: 15/442,545

(22) Filed: Feb. 24, 2017

(51) Int. Cl. G06F 21/53; G06F 9/455

(52) U.S. Cl. CPC G06F 21/53; G06F 2221/033; G06F 9/45508

(57) ABSTRACT

A method is provided for protecting a host device from untrusted applications. Upon detecting an initial installation and/or execution of an application, the application is executed within a first virtual machine having a first level of monitoring and/or operating constraints. The application may be executed alone in the first virtual machine. Operation of the application may be monitored to ascertain the level of trust for the application. Upon ascertaining a change in a level of trust in the application, the application may be migrated to execute within a second virtual machine having a second level of monitoring and/or operating constraints, wherein the second level of monitoring and/or operating constraints has different operating restrictions than the first level of monitoring and/or operating constraints.

### TECHNICAL FIELD

Various novel aspects disclosed herein generally relate to protecting devices from untrusted applications, and more specifically, though not exclusively, to methods for detecting and inhibiting security threats from untrusted applications.

### BACKGROUND

There is an ever increasing need to protect user devices from security risks posed by applications. For instance, untrusted applications (e.g., unvetted applications, applications of unknown/untrusted sources, etc.) can be loaded on a user device in various ways, e.g., loaded from a trusted or untrusted application store, side loading, and/or installed directly through root access. This is problematic for endpoint protection solutions, particularly solutions administered by a centralized administrator. If a user device is a personal device, the enterprise may be limited in what it can do to prevent untrusted applications from being loaded and executed by the user device. Yet many enterprises are allowing personal devices to access the corporate intranet and enterprise data, which may expose them to attacks or security breaches by untrusted applications.

One approach to address the risk posed by untrusted applications is the use of antivirus (AV) software which may detect downloaded applications or software processes that are potentially harmful. For instance, digital or cryptographic signatures for the untrusted application may be verified by the AV software or the runtime behavior of the untrusted software may be monitored to ascertain suspicious or threatening behavior. However, such signature-based and machine-learning based approaches can be defeated by hostile parties through extensive observation and novel attack approaches. Upon discovering unknown or untrusted applications, some approaches may upload the unknown/untrusted applications to a detonation server to determine the application's behavior. However, the use of a detonation server in this manner may delay realization of the utility of the unknown/untrusted application, particularly when connectivity is poor or unavailable, because the user must wait for approval. If the end user is permitted to continue to use the untrusted application while detonation is ongoing, it exposes the user device to potentially harmful operations.

A solution is needed that allows untrusted applications to be executed on user devices while minimizing damage or security risks to the corporate intranet and/or enterprise data.

### SUMMARY

A method for protecting a host device from untrusted applications is provided. An initial installation and/or execution of an application is detected on the host device. Upon detecting the initial installation and/or execution of the application, the application is executed within a first virtual machine having a first level of monitoring and/or operating constraints. The application may be monitored to ascertain the level of trust for the application. The application may be migrated to execute within a second virtual machine having a second level of monitoring and/or operating constraints upon ascertaining a change in a level of trust in the application, wherein the second level of monitoring and/or operating constraints has different operating restrictions than the first level of monitoring and/or operating constraints. If the level of trust in the application increases, the second level of monitoring and/or operating constraints may be less restrictive than the first level of monitoring and/or operating constraints. Otherwise, if the level of trust in the application decreases, the second level of monitoring and/or operating constraints are more restrictive than the first level of monitoring and/or operating constraints.

In some implementations, the application may be executed alone in the first virtual machine and the second virtual machine.

According to one aspect, even if the level of trust in the application increases, migrating the application may be further dependent on frequency of use of the application at the host device.

In various implementations, migrating the application from the first virtual machine to the second virtual machine may be further based on least one of: (a) expiration of a threshold amount time over which the application has run without exhibiting known anomalous behavior in the first virtual machine, (b) receipt of external information indicating that a plurality of other devices found the application trustworthy. (c) receipt of external information indicating that a third party service found the application trustworthy, and/or (d) a change in the level of trust ascertained by an independent evaluation at the host device.

According to yet another aspect, the application may be sent to an external detonation server for evaluation. An indication of trustworthiness may then be received from the external detonation server, wherein the application is moved from the first virtual machine to the second virtual machine if the indication of trustworthiness exceeds a threshold level.

In one example, the first level of monitoring and/or operating constraints include at least one of: (a) monitoring inputs or outputs for the first virtual machine, (b) restricting, watermarking, and/or tracing data in/out of the application, (c) detecting application execution failures for the application due to resource availability, and/or (d) simulating or obfuscating input data for the application.

Another feature provides a device, comprising a communication circuit and a processing circuit. The processing circuit may be configured to: (a) detect initial installation and/or execution of an application on the host device, (b) execute the application, upon detecting the initial installation and/or execution of the application, within a first virtual machine having a first level of monitoring and/or operating constraints, and/or (c) migrate the application to execute within a second virtual machine having a second level of monitoring and/or operating constraints upon ascertaining an increase in a level of trust in the application, wherein the second level of monitoring and/or operating constraints has different operating restrictions than the first level of monitoring and/or operating constraints.

In various examples, migrating the application from the first virtual machine to the second virtual machine may be based on at least one of: (a) expiration of a threshold amount time over which the application has run without exhibiting known anomalous behavior in the first virtual machine, (b) receipt of external information indicating that a plurality of other devices found the application trustworthy, (c) receipt of external information indicating that a third party service found the application trustworthy, and/or (d) a change in the level of trust ascertained by an independent evaluation at the host device.

According to one aspect, the first level of monitoring and/or operating constraints may include at least one of: (a) monitoring inputs or outputs for the first virtual machine, (b) restricting, watermarking, and/or tracing data in/out of the application, (c) detecting application execution failures for the application due to resource availability, and/or (d) simulating or obfuscating input data for the application.

Yet another feature provides a method for implementing origin-associated privileges by a web browser on a host device.

The web browser may detect that a website for a domain of unknown trustworthiness is to be loaded. Operating privileges for the website may be restricted, relative to standard operating privileges for the web browser, to limit the website's access to host device information and/or resources. The website may be loaded into the web browser. The website operation may be monitored to ascertain the level of trust for the domain. According to an optional aspect, an external server or third party may be requested to ascertain the level of trust for the domain The operating privileges for the website may be adjusted upon ascertaining a change in the level of trust for the website or domain. If the level of trust increases, the web browser may adjust operating privileges for the website to make them less restrictive. Otherwise if the level of trust decreases, the web browser adjusts operating privileges for the website to make them more restrictive.

### DRAWINGS

FIG. 1 is an exemplary block diagram illustrating how a host device may be protected while executing an untrusted application.

FIG. 2 is a block diagram illustrating a host device configured to dynamically restrict execution of untrusted applications by use of virtual machines.

FIG. 3 (comprising FIGS. 3A and 3B) illustrates a method operational by a host device to dynamically restrict execution of untrusted applications by use of virtual execution environments.

FIG. 4 illustrates a method operational by a web browser in a host device to dynamically restrict operating privileges for a website being loaded.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

### Overview

One aspect provides a way to execute an untrusted application on a host device while minimizing or eliminating the potential for security threats to data and/or resources of the host device.

According to one approach, a hypervisor or application manager operating in the host device may initially install an untrusted application in a first virtual machine (VM A), operating within the host device, where it can be restricted and monitored. The first virtual machine (VM A) may have monitored or restricted access to host device resources (e.g., memory, ports, etc.), which inhibits or restricts the untrusted application from causing harm to the host device or risking, exposing, and/or changing data stored therein. After a period of time, or as additional trust is gained in the application, the hypervisor or application manager may move the application to a second virtual machine B that may have different operating constraints (e.g., which in their totality are less restrictive) than the first virtual machine A. This process may continue with additional virtual machines that are gradually less restrictive as greater trust is gained in the application.

This concept may be extended to a browser that automatically implements origin-associated privileges for websites as they are loaded, where the level of privilege is based on the origin or trustworthiness of a domain from which a website originates. Such privileges may serve to restrict access to device information and/or resources until the device/browser ascertains whether less restrictive privileges are warranted for the domain.

Exemplary Aspect to Protect Host Device from Untrusted Application

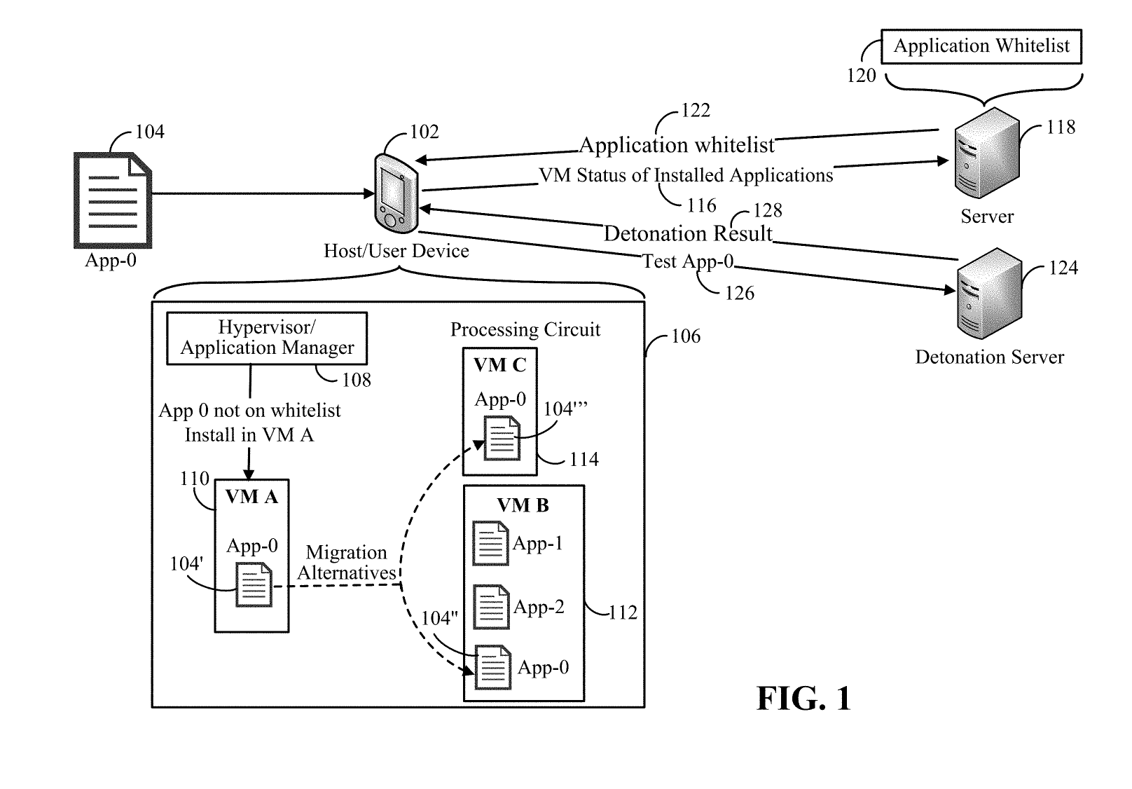

FIG. 1 is an exemplary block diagram illustrating how a host device may be protected while executing an untrusted application. Examples of the host device 102 include a mobile phone, a wireless phone, a smartphone, a tablet, a personal digital assistant, a mobile communication device, a system-on-a-chip (SoC), among other devices (e.g., wearable devices, internet of things IOT devices, etc.). The host device 102 may have an untrusted application 104 installed therein. For instance, a processing circuit 106 within the host device 102 may implement, execute, and/or run a hypervisor or application manager 108 that manages execution of one or more virtual machines VM A 110, VM B 112, and VM C 114 and applications App-0, App-1, and App-2 loaded/executed therein.

In various examples, the hypervisor or application manager 108 may be software, firmware, and/or hardware that creates and/or runs the one or more virtual machines 110, 112, and 114. The hypervisor or application manager 108 may manage execution of the virtual machines 110, 112, and 114 and guest operating systems therein. Multiple virtual machines 110, 112, and 114 may share the virtualized hardware resources, e.g., processing resources, memory resources, network resources, etc.

In one example, a virtual machine (VM) is an emulation of a computer system. Virtual machines are typically based on computer architectures and provide functionality of a physical computer needed to execute entire operating systems. The hypervisor or application manager 108 may use native execution to share and manage hardware, allowing for multiple environments (e.g., virtual machines) which are isolated from one another, yet exist on the same physical machine.

In one implementation, prior to loading an unknown or untrusted application App-0 104, the hypervisor/application manager 108 may send a message 116, to check the trustworthiness of the unknown/untrusted application App-0 104, to a cloud server 118. In response, the server 118 may check an application whitelist 120 to ascertain a trust level the unknown/untrusted application App-0 104 (e.g., by reviewing a trust history for the unknown/untrusted application, and/or comparing a received application digital signature to a trusted digital signature for the application from the whitelist 120, etc.). The server 118 sends a reply 122 indicating whether the unknown/untrusted application App-0 104 can be trusted. If it is ascertained that the unknown/untrusted application App-0 104 is not in the whitelist 120 or cannot be trusted, the hypervisor/application manager 108 may then install the untrusted application App-0 104′ in a first virtual machine VM A 110 which has restricted resources or access. For instance, the restrictions may limit the first virtual machine VM A 110 to use of certain memory regions (e.g., inhibit access to other memory regions used by other applications or virtual machines), restrict sockets and/or ports used by the first virtual machine, and/or restrict access to a network connection or storage on the host device 102. Additionally, use of resources by the first virtual machine VM A 110 may be monitored and/or adjusted/manipulated by the hypervisor/application manager 108 (e.g., including altering data within the virtual machine, inserting fake data within the virtual machine, etc.) to ascertain a level of trust for the untrusted application App-0 104′. For instance, if unexpected or unauthorized operations are being attempted by the untrusted application App-0 104′ within the virtual machine, this may reduce/decrease the level of trust for the application App-0 104′. In this manner, the untrusted application App-0 104′ may be allowed to execute while still preventing it from causing harm (e.g., accessing user/confidential data, loading unauthorized applications, inserting a virus, etc.) to the host device 102.

In another implementation, rather than first ascertaining a trust level for the unknown/untrusted application App-0 104, the untrusted application App-0 104′ may simply be loaded and executed within the restricted first virtual machine VM A 110. This may expedite utilization of the application App-0 104 without delay while still protecting the host device or data therein from unauthorized access. If trust level information for the application is subsequently obtained, it may serve to adjust operating restrictions for the application (e.g., within the first virtual machine or move the application to another virtual machine).

According to one aspect, the first virtual machine VM A 110 may execute just one untrusted application App-0 104′ at a time so as to inhibit its effect on other applications.

As the hypervisor/application manager 108 ascertains more information about the trustworthiness of the untrusted application App-0 104′ (e.g., after a threshold amount of execution time, after receiving information from an external source indicating a trustworthiness or risk posed by the application, or after monitoring application operations, etc.), the untrusted application App-0 104′ may be moved to a less restrictive virtual machine or a more restrictive virtual machine. For instance, if the hypervisor/application manager 108 concludes that the application App-0 104 is more trustworthy than when installed, it may migrate (e.g., move or reinstall) the application App-0 to a second virtual machine (e.g., VM B 112 or VM C 114) with less restrictions than the first virtual machine VM A 110. Alternatively, if the hypervisor/application manager 108 concludes that the application App-0 104 is less trustworthy than when installed, it may migrate (e.g., move or reinstall) the application App-0 to a third virtual machine (e.g., VM B 112 or VM C 114) with more restrictions than the first virtual machine VM A 110.

This process may continue with moving or migrating execution of the untrusted application 104 either to less restrictive or more restrictive virtual machines depending on the behavior of the application 104. To move an application between virtual environments, it may be uninstalled from one virtual environment and moved to another virtual environment.

According to another aspect, while the untrusted application 104 is being executed in the first virtual machine VM A 110 within the host/user device 102, the host/user device 102 may use an external detonation server 124 to evaluate the untrusted application 104. For instance, the host device 102 may send the untrusted application App-0 104 to the detonation server 124 for testing 126. The detonation server 124 may execute, test, and/or monitor the application to evaluate or ascertain whether the application App-0 can be trusted. The detonation server 124 may then provide a result of its evaluation 128 to the host device 102. Depending on the evaluation of the detonation server 124, the application 104′ in the host/user device 102 may be moved to a more restrictive or less restrictive virtual machine.

One feature also provides for the hypervisor/application manager and/or virtual machine to send execution results (for the untrusted application) to the central server 118 and/or detonation server 124. In this manner, execution results/data from a plurality of host devices and/or virtual machines can be sent to a central server to further protect a larger community of devices/users.

In some implementations, the host device 102 may use the same virtual machines in which to execute multiple applications of limited or unknown trustworthiness. In one example, the untrusted application 104′ may be moved from the first virtual machine 110 to the second virtual machine 112 or 114 upon at least one of: (a) expiration of a threshold amount time over which the untrusted application has run without exhibiting known anomalous behavior in the first virtual machine, (b) receipt of external information indicating that a plurality of other user devices found the untrusted application trustworthy, and/or (c) receipt of external information indicating that a third party service found the untrusted application trustworthy.

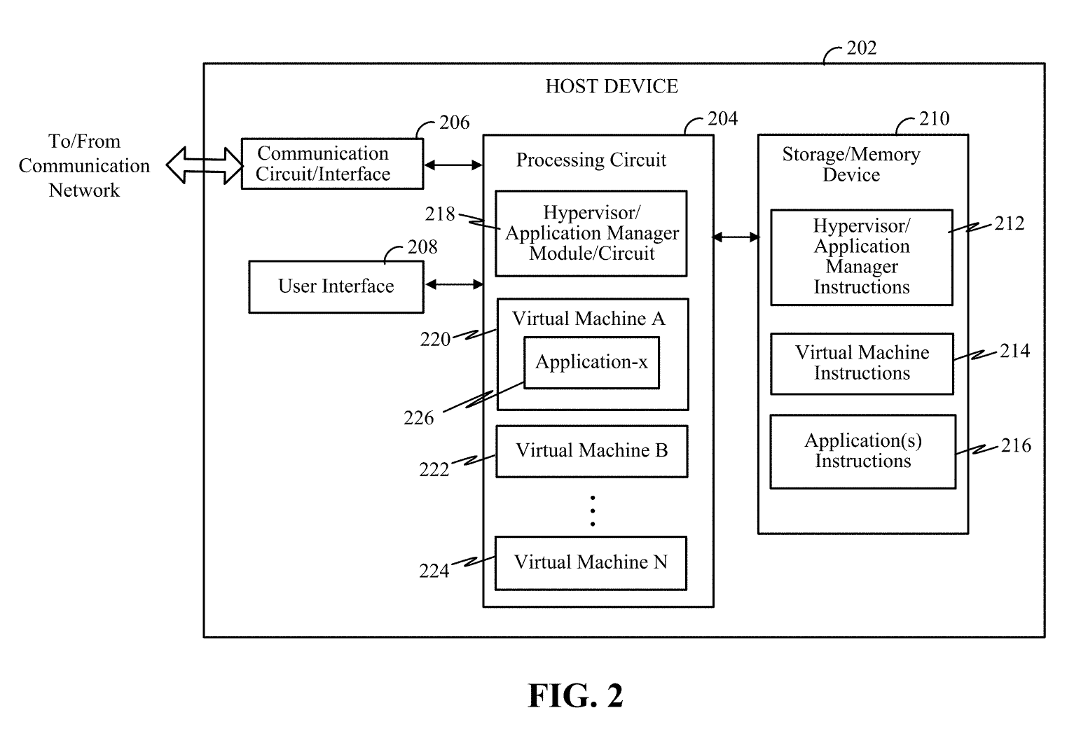

FIG. 2 is a block diagram illustrating a host device configured to dynamically restrict execution of untrusted applications by use of virtual machines. The host device 202 may include a processing circuit 204 coupled to a communication circuit/interface 206, a user interface 208, and/or a storage/memory device 210. The communication circuit/interface 206 may include a wired and/or wireless transmitter circuit and/or receiver circuit that permits the host device 202 to communicate over a communication network. The user interface 208 may include an output device (e.g., display screen, speaker, etc.) and/or an input device (e.g., keypad, touchscreen, microphone, etc.). The storage/memory device 210 may include hypervisor/application manager instructions 212 (e.g., for executing a hypervisor or application manager), virtual machine instructions 214 (e.g., for virtual machines being executed), and/or application(s) instructions 216 (e.g., for applications being executed by the host device).

The processing circuit 204 may include (or is configured to implement) a hypervisor/application manager module/circuit 218, and one or more virtual machines 220, 222, and/or 224. As a new or untrusted application 226 is loaded for execution, the hypervisor/application manager module/circuit 218 may automatically start/load a first virtual machine 220 and executes the untrusted application 226 within the first virtual machine 220. The first virtual machine 220 may have restricted resources to prevent or inhibit the untrusted application 226 from accessing, divining, and/or changing certain information on the host device 202 and/or causing harm to the host device 212 (e.g., prevent access to confidential or private data, prevent installing or executing a virus or snooping software, prevent unauthorized use of host device resources, etc.).

The hypervisor/application manager module/circuit 218 may monitor the behavior of the untrusted application 226, such as network access, data access, processing resources used, ports used, sensor access (e.g., camera, microphone, etc.), memory used, data transmitted/received, etc., to ascertain whether the application 226 can be trusted. For instance, time thresholds of execution and/or resource usage thresholds may be used by the hypervisor/application manager module/circuit 218 to ascertain a trustworthiness for the application 226.

Additionally, the hypervisor/application manager module/circuit 218 may contact an external server to verify the trustworthiness of the application 226. The hypervisor/application manager module/circuit 218 may send any identifying information to the external server that can serve to identify the untrusted application 226. For instance, the hypervisor/application manager module/circuit 218 may attempt to confirm a digital signature associated with the application 226 with the external server, send a binary version of the untrusted application 226 to the external server, and/or send information about behavior pattern of the untrusted application 226 to the external server. If the digital signature is confirmed by the external server, then the hypervisor/application manager module/circuit 218 may consider the application 226 more trustworthy.

Similarly, the hypervisor/application manager module/circuit 218 may request an external detonation server to execute the application 226 (e.g., another instance of the application 226) to evaluate if it may cause harm to the host device 202 or expose/corrupt data therein.

The host device 202 may use one or more of these evaluation approaches to ascertain a trustworthiness (e.g., a trust level) for the application 226. In one example, as greater trustworthiness on the application 226 is obtained, the hypervisor/application manager module/circuit 218 may migrate the application 226 (e.g., uninstall from current virtual machine and install in a new virtual machine) to a less restrictive virtual machine. Note that all conceivable ways of migrating the application 226 (e.g., moving files, copying files, new installation, partial installation, etc.) are contemplated herein. In another example, if the application 226 becomes less trustworthy, the hypervisor/application manager module/circuit 218 may uninstall the application 226 or migrate it (e.g., uninstall from current virtual machine and install in a new virtual machine) to a more restrictive/secure virtual machine. In various implementations, several factors (not just trustworthiness or trust level of the application) may be evaluated or weighed in ascertaining whether to migrate the application 226. For example, even if the level of trust in the application increases, migrating the application is further dependent on frequency of use of the application at the host device. For instance, if the application 226 is rarely used (e.g., low frequency of execution), then there may be no need to migrate even if the level of trust increases. For instance, the hypervisor or application manager may determine an application does not need to be migrated to a virtual machine with fewer restrictions because the application is seldom used (e.g., frequency of use is less than a threshold frequency of usage).

In some implementations, the application may be executed alone in the current virtual machine and the new virtual machine so as to prevent exposing other applications to security risks posed by the untrusted application. In other implementations, once the application has gained a certain threshold level of trust, it may be migrated into a virtual machine shared with other applications.

This evaluation process may be repeated as the application 226 is migrated to a new virtual machine. In some implementations, the level of trustworthiness may increase with the passage of execution time without incidents of suspicious activity by the application. In some instances, the application 226 may be executed in dedicated virtual machines (e.g., no other applications executed in the virtual machine). After an increased level of trust is associated with the application 226, the application 226 may be migrated to a virtual machine which executes one or more other applications.

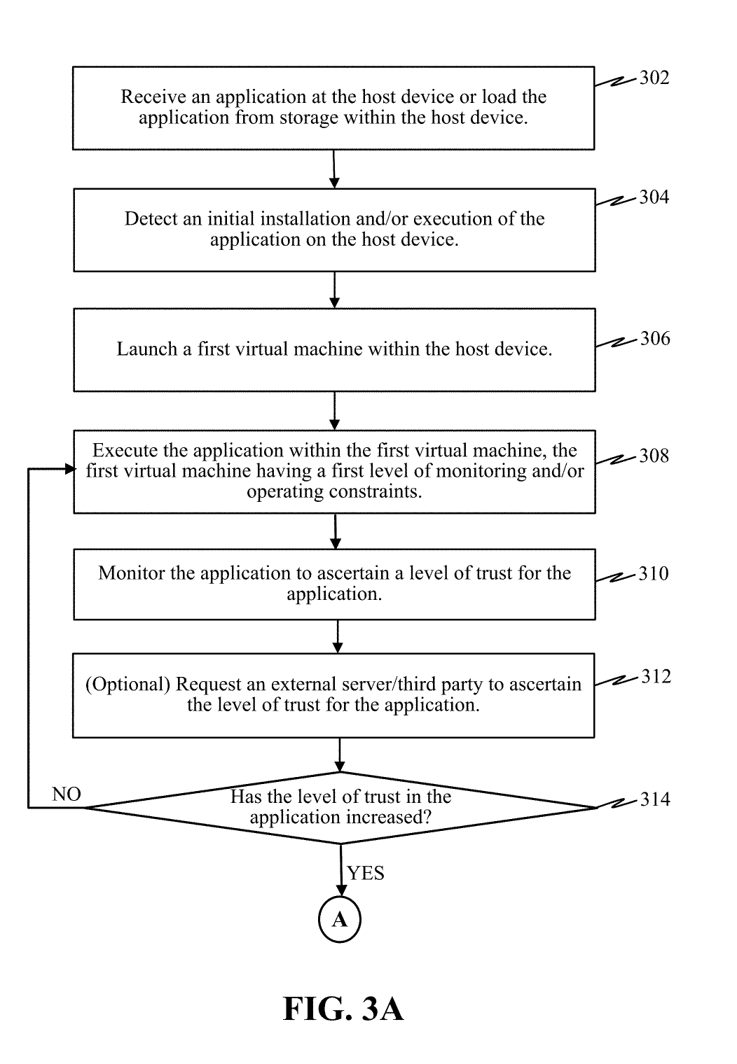

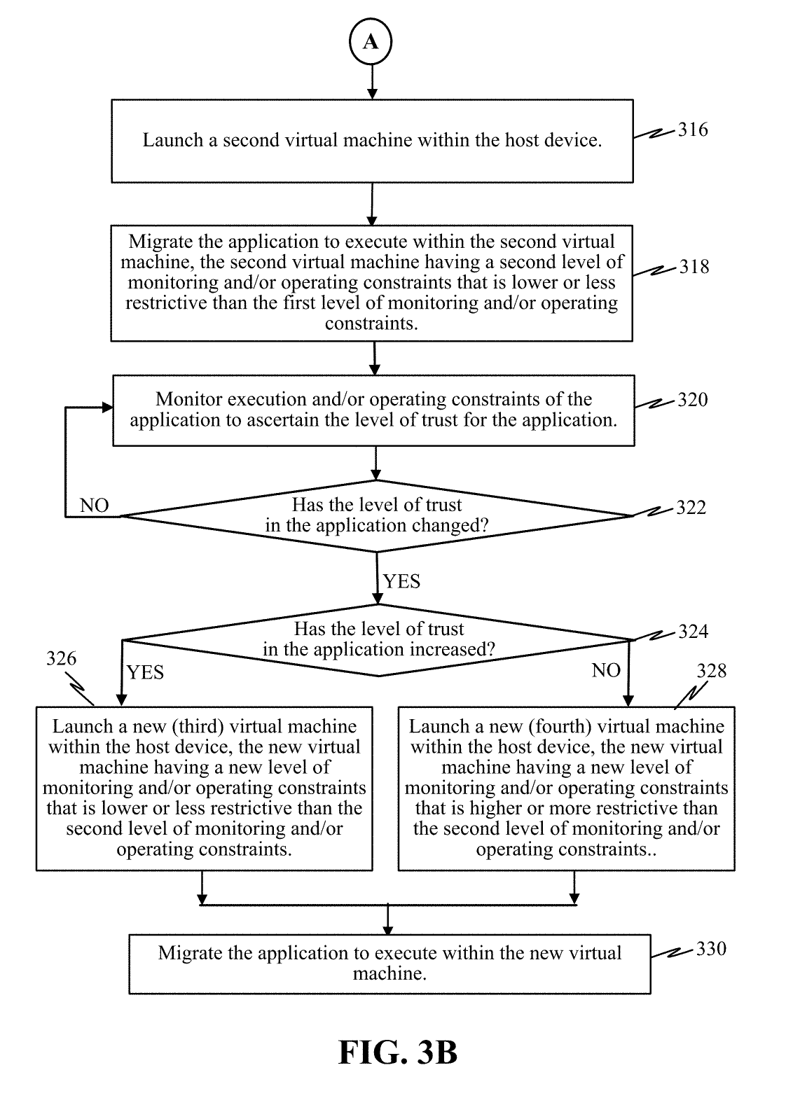

FIG. 3 (comprising FIGS. 3A and 3B) illustrates a method operational by a host device to dynamically restrict execution of untrusted applications by use of virtual execution environments. An application may be received at the host device or loaded from storage within the host device 302. In some instances, an initial installation and/or execution of an application on the host device may be detected 304. According to one implementation, the first virtual machine may be launched only upon deciding to execute the application 306. The application may be executed within a first virtual machine having a first level of monitoring and/or operating constraints 308. During execution, the application may be monitored to ascertain the level of trust for the application 310. Generally, if a change in a level of trust in the application is ascertained, wherein the second level of monitoring and/or operating constraints has different operating restrictions than the first level of monitoring and/or operating constraints.

If the level of trust in the application increases 314, the application may be migrated to another virtual machine. For instance, a second virtual machine may be launched within the host device 316 only after a decision is made to migrate the application. The application may then be migrated (e.g., uninstalled from the first virtual machine and installed in the second virtual machine) to execute within a second virtual machine having a second level of monitoring and/or operating constraints upon ascertaining an increase in a level of trust in the application, wherein the second level of monitoring and/or operating constraints is lower or less restrictive than the first level of monitoring and/or operating constraints 318.

During execution in the second virtual machine, the application may also be monitored to ascertain the level of trust for the application 320. If the level of trust changes 322, it may be ascertained whether such level of trust has increased or decreased 324.

Upon ascertaining an increase in the level of trust in the application (e.g., the application is more trustworthy), the application may be migrated to execute within a new (third) virtual machine having a new (third) level of monitoring and/or operating constraints, wherein the new (third) level of monitoring and/or operating constraints is lower or less restrictive than the second level of monitoring and/or operating constraints 326. Alternatively, upon ascertaining a decrease in the level of trust in the application (e.g., the application is less trustworthy), the application may be migrated to execute within a new (fourth) virtual machine having a new (fourth) level of monitoring and/or operating constraints, wherein the new (fourth) level of monitoring and/or operating constraints is higher or more restrictive than the second level of monitoring and/or operating constraints 328. The application may then be migrated to execute within the new virtual machine 330. This process or migrating and monitoring the application may continue until such time as the application is deemed to be safe (e.g., high level of trustworthiness) or it is uninstalled or its execution is blocked because it is deemed to be too risky or harmful (e.g., low level of trustworthiness).

In some instances, the host device may request an external server/third party to ascertain the level of trust for the application 312. For instance, the host device may send the application to an external detonation server for evaluation. In response, the host device may receive an indication of trustworthiness from the external detonation server, wherein the application is moved from the first virtual machine to the second virtual machine if the indication of trustworthiness exceeds a threshold level.

According to various examples, the application may be migrated from the first virtual machine to the second virtual machine upon at least one of: (a) expiration of a threshold amount time over which the application has run without exhibiting known anomalous behavior in the first virtual machine, (b) receipt of external information indicating that a plurality of other devices found the application trustworthy, (c) receipt of external information indicating that a third party service found the application trustworthy (or a certain level of trust), and/or (d) a change in the level of trust ascertained by an independent evaluation at the host device (e.g., static analysis of the application, or based on monitored behavior of the application). In one example, the hypervisor/application manager may compute/obtain a “trust score” based on one or more factors to ascertain a level of trust or trustworthiness.

According to one implementation, the first level of monitoring and/or operating constraints may include at least one of: (a) monitoring inputs or outputs for the first virtual machine, (b) restricting, watermarking, and/or tracing data in/out of the application, (c) detecting application execution failures for the application due to resource availability, and/or (d) simulating or obfuscating input data for the application (e.g., location information, acceleration/gyroscopic/compass data, camera data, microphone data, hardware information, etc.), and/or (e) detecting access requests for data and resources.

This concept of dynamically adjusting access to an untrusted application may also be extended to web browsers and untrusted websites. For instance, as a web browser, running on a host device, may be requested to load an untrusted website. In order to protect the hosting device and/or information therein, the web browser may dynamically restrict execution/access privileges for the website.

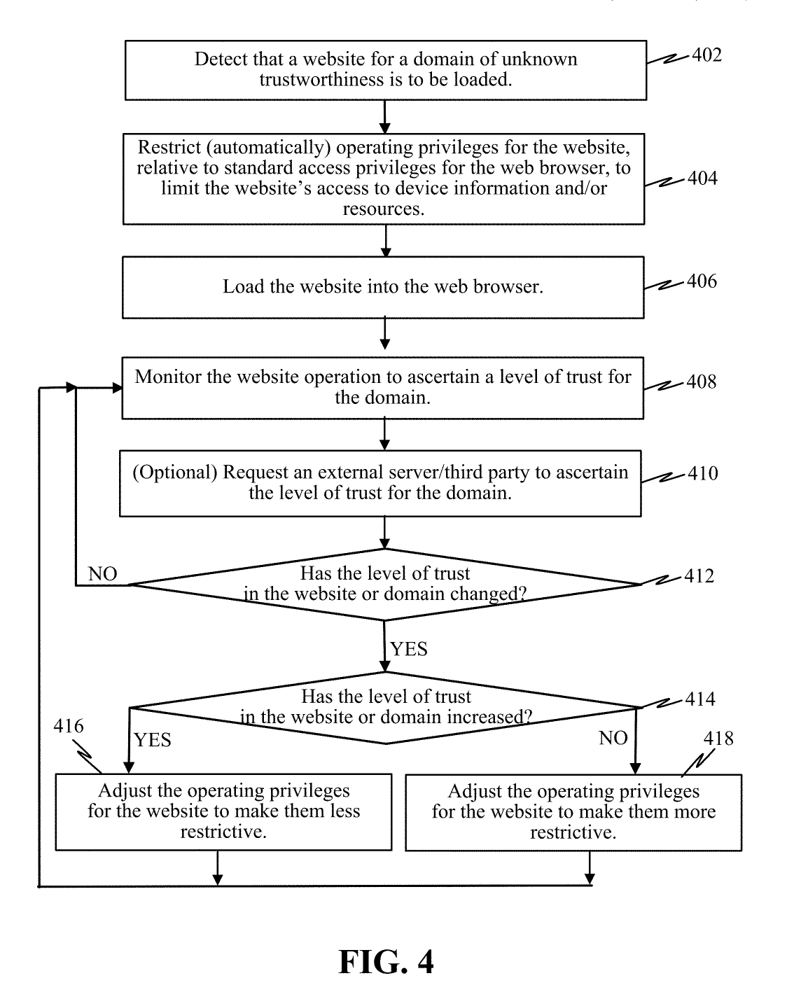

FIG. 4 illustrates a method operational by a web browser in a host device to dynamically restrict operating privileges for a website being loaded. The web browser may detect that a website for a domain of unknown trustworthiness is to be loaded 402. The web browser may then (automatically) restrict operating (e.g., execution or access) privileges for the website, relative to standard operating (e.g., execution and/or access) privileges for the web browser, to limit the website's access to device information and/or resources 404. The website may then be loaded into the web browser 406. The web browser may then monitor the website operation (e.g., command being executed, access) to ascertain a level of trust for the domain 408 (or the website or webpage). Optionally, the web browser may request an external server or third party to ascertain the level of trust for the domain 410 (or the website or webpage). If the level of trust in the website or domain have changed 412, the web browser may ascertain whether such level of trust has increased or decreased 414. If the level of trust has increased, the web browser may adjust access (e.g., execution and/or access) privileges for the website to make them less restrictive 416. Otherwise, if the level of trust has decreased, the web browser may adjust operating (e.g., execution and/or access) privileges (or terminate display of the website) for the website to make them more restrictive 418.

While the above discussed aspects, arrangements, and embodiments are discussed with specific details and particularity, one or more of the components, steps, features and/or functions illustrated in FIGS. 1, 2, 3 and/or 4 may be rearranged and/or combined into a single component, step, feature or function or embodied in several components, steps, or functions. Additional elements, components, steps, and/or functions may also be added or not utilized without departing from the present disclosure. The novel algorithms described herein may also be efficiently implemented in software and/or embedded in hardware.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational at a host device, comprising:
detecting an initial installation and/or execution of an application on the host device;
executing the application, upon detecting the initial installation and/or execution of the application, within a first virtual machine having a first level of monitoring and/or operating constraints; and
migrating the application to execute within a second virtual machine having a second level of monitoring and/or operating constraints upon ascertaining a change in a level of trust in the application, wherein the second level of monitoring and/or operating constraints has different operating restrictions than the first level of monitoring and/or operating constraints.

2. The method of claim 1, further comprising:
monitoring the application to ascertain the level of trust for the application.

3. The method of claim 1, wherein the application is executed alone in the first virtual machine and the second virtual machine.

4. The method of claim 1, wherein even if the level of trust in the application increases, migrating the application is further dependent on frequency of use of the application at the host device.

5. The method of claim 1, wherein
the second level of monitoring and/or operating constraints are less restrictive than the first level of monitoring and/or operating constraints if the level of trust in the application increases, and
the second level of monitoring and/or operating constraints are more restrictive than the first level of monitoring and/or operating constraints if the level of trust in the application decreases.

6. The method of claim 1, wherein migrating the application from the first virtual machine to the second virtual machine is further based on least one of:
(a) expiration of a threshold amount time over which the application has run without exhibiting known anomalous behavior in the first virtual machine,
(b) receipt of external information indicating that a plurality of other devices found the application trustworthy,
(c) receipt of external information indicating that a third party service found the application trustworthy and/or
(d) a change in the level of trust ascertained by an independent evaluation at the host device.

7. The method of claim 1, further comprising:
sending the application to an external detonation server for evaluation; and
receiving an indication of trustworthiness from the external detonation server, wherein the application is moved from the first virtual machine to the second virtual machine if the indication of trustworthiness exceeds a threshold level.

8. The method of claim 1, wherein the first level of monitoring and/or operating constraints include at least one of:
(a) monitoring inputs or outputs for the first virtual machine,
(b) restricting, watermarking, and/or tracing data in/out of the application,
(c) detecting application execution failures for the application due to resource availability, and/or
(d) simulating or obfuscating input data for the application.

9. A device, comprising
a communication circuit; and
a processing circuit coupled to the communication circuit, the processing circuit configured to:
detect initial installation and/or execution of an application on the host device,
execute the application, upon detecting the initial installation and/or execution of the application, within a first virtual machine having a first level of monitoring and/or operating constraints, and
migrate the application to execute within a second virtual machine having a second level of monitoring and/or operating constraints upon ascertaining an increase in a level of trust in the application, wherein the second level of monitoring and/or operating constraints has different operating restrictions than the first level of monitoring and/or operating constraints.

10. The device of claim 9, wherein the processing circuit is further configured to:
monitor the application to ascertain the level of trust for the application.

11. The device of claim 9, wherein the application is executed alone in the first virtual machine and the second virtual machine.

12. The device of claim 9, wherein the second level of monitoring and/or operating constraints are less restrictive than the first level of monitoring and/or operating constraints if the level of trust in the application increases, and
the second level of monitoring and/or operating constraints are more restrictive than the first level of monitoring and/or operating constraints if the level of trust in the application decreases.

13. The device of claim 9, wherein migrating the application from the first virtual machine to the second virtual machine is based on at least one of:
(a) expiration of a threshold amount time over which the application has run without exhibiting known anomalous behavior in the first virtual machine,
(b) receipt of external information indicating that a plurality of other devices found the application trustworthy,
(c) receipt of external information indicating that a third party service found the application trustworthy, and/or
(d) a change in the level of trust ascertained by an independent evaluation at the host device.

14. The device of claim 9, wherein the first level of monitoring and/or operating constraints include at least one of:
(a) monitoring inputs or outputs for the first virtual machine,
(b) restricting, watermarking, and/or tracing data in/out of the application,
(c) detecting application execution failures for the application due to resource availability, and/or
(d) simulating or obfuscating input data for the application.

15. A method for implementing origin-associated privileges by a web browser on a host device, comprising:
detecting that a website for a domain of unknown trustworthiness is to be loaded;
restricting operating privileges for the website, relative to standard operating privileges for the web browser, to limit the website's access to host device information and/or resources;
loading the website into the web browser; and
adjusting the operating privileges for the website upon ascertaining a change in the level of trust for the website or domain.

16. The method of claim 15, further comprising:
monitoring the website operation to ascertain the level of trust for the domain.

17. The method of claim 15, further comprising:
requesting an external server or third party to ascertain the level of trust for the domain.

18. The method of claim 15, wherein if the level of trust has increased, the web browser adjusts operating privileges for the website to make them less restrictive.

19. The method of claim 15, wherein if the level of trust has decreased, the web browser adjusts operating privileges for the website to make them more restrictive.
